(19) United States
(12) Patent Application Publication
(10) Pub. No.: US 2005/0146521 A1
(43) Pub. Date: Jul. 7, 2005

(54) Method for creating and presenting an accurate reproduction of three-dimensional images converted from two-dimensional images

(76) Inventors: Michael C. Kaye, Agoura Hills, CA (US); Charles J.L. Best, Los Angeles, CA (US)

Correspondence Address: HENRICKS SLAVIN AND HOLMES LLP;SUITE 200, 840 APOLLO STREET, EL SEGUNDO, CA, 90245, US

(21) Appl. No.: 10/792,368

(22) Filed: Mar. 2, 2004

Related U.S. Application Data
(63) Continuation-in-part of application No. 10/674,688, filed on Sep. 30, 2003.
Application No. 10/674,688 is a continuation-in-part of application No. 10/316,672, filed on Dec. 10, 2002.
Application No. 10/316,672 is a continuation-in-part of application No. 10/147,380, filed on May 15, 2002.
Application No. 10/147,380 is a continuation-in-part of application No. 10/029,625, filed on Dec. 19, 2001, now Pat. No. 6,515,659.
Application No. 10/029,625 is a continuation-in-part of application No. 09/819,420, filed on Mar. 26, 2001, now Pat. No. 6,686,926.
Application No. 09/819,420 is a continuation-in-part of application No. 09/085,746, filed on May 27, 1998, now Pat. No. 6,208,348.

(51) Int. Cl. G06T 15/00

(52) U.S. Cl. 345/419

(57) ABSTRACT

A method for providing a three-dimensional image includes selecting a screen size or range of screen sizes for a three-dimensional image and scaling depth information associated with objects in a three-dimensional image to preserve perceived depths of the objects when the three-dimensional image is presented at the screen size or within the range of screen sizes selected.

### CROSS-REFERENCE TO RELATED APPLICATIONS

This application is a continuation-in-part of U.S. patent application Ser. No. 10/674,688 entitled “Method For Minimizing Visual Artifacts Converting Two-Dimensional Motion Pictures Into Three-Dimensional Motion Pictures” filed on Sep. 30, 2003, which is a continuation-in-part of U.S. patent application Ser. No. 10/316,672 entitled “Method Of Hidden Surface Reconstruction For Creating Accurate Three-Dimensional Images Converted From Two-Dimensional Images” filed on Dec. 10, 2002, which is a continuation-in-part of U.S. patent application Ser. No. 10/147,380 entitled “Method For Conforming Objects To A Common Depth Perspective For Converting Two-Dimensional Images Into Three-Dimensional Images” filed on May 15, 2002, which is a continuation-in-part of U.S. patent application Ser. No. 10/029,625 entitled “Method And System For Creating Realistic Smooth Three-Dimensional Depth Contours From Two-Dimensional Images” filed on Dec. 19, 2001, now U.S. Pat. No. 6,515,659, which is a continuation-in-part of U.S. patent application Ser. No. 09/819,420 entitled “Image Processing System And Method For Converting Two-Dimensional Images Into Three-Dimensional Images” filed on Mar. 26, 2001, now U.S. Pat. No. 6,686,926, which is a continuation-in-part of U.S. patent application Ser. No. 09/085,746 entitled “System And Method For Converting Two-Dimensional Images Into Three-Dimensional Images” filed on May 27, 1998, now U.S. Pat. No. 6,208,348, all of which are incorporated herein by reference in their entirety.

### BACKGROUND OF THE INVENTION

In the process of converting a two-dimensional (2D) image into a three-dimensional (3D) image, at least two perspective angle images are needed independent of whatever conversion or rendering process is used. In one example of a process for converting two-dimensional images into three-dimensional images, the original image is established as the left view, or left perspective angle image, providing one view of a three-dimensional pair of images. In this example, the corresponding right perspective angle image is an image that is processed from the original image to effectively recreate what the right perspective view would look like with the original image serving as the left perspective frame. Although in this example the right image is the newly created image, the reverse could also be the case whereby the left image is the newly created image and the right image is the original, or both the left and the right images could be created.

In the process of creating a 3D perspective image out of a 2D image, as in the above example, objects or portions of objects within the image are repositioned along the horizontal, or X axis. By way of example, an object within an image can be “defined” by drawing around or outlining an area of pixels within the image. Once such an object has been defined, appropriate depth can be “assigned” to that object in the resulting 3D image by horizontally shifting the object in the alternate perspective view. To this end, depth placement algorithms or the like can be assigned to objects for the purpose of placing the objects at their appropriate depth locations.

As screen (image) size increases, the left/right (horizontal) displacements of objects in the 3D image also increase relative to the spacing between a viewer's left and right eyes, which is typically around 65 mm. Thus, by way of example, a 3D image may have been created for display on a 30 inch screen. If this same 3D image is instead presented on a 30 foot screen, foreground objects in the image will appear to shift more toward the viewer while background objects in the image will appear to shift further away. Essentially, as the screen (image) size increases, the depth effect becomes over-exaggerated. Unfortunately, this over-exaggeration of depth in foreground and background image components can cause eye fatigue and headaches.

The reverse scenario can also be problematic. If the depth properties of a 3D image are optimized for a 30 foot screen, the viewer seeing the same images on a 30 inch wide display may see little to no depth effect as the depth will become compressed down.

In view of the foregoing, it would be desirable to be able to provide 3D images in such a manner that the problems associated with presenting 3D images on different sized screens are significantly minimized or eliminated. It would also be desirable to be able to improve the processing performance during the conversion of 2D images to 3D images.

### BRIEF DESCRIPTION OF THE DRAWINGS

Detailed description of embodiments of the invention will be made with reference to the accompanying drawings:

FIG. 1A illustrates a person (viewer) wearing 3D glasses, positioned one screen width distance away from a 30 inch wide screen.

FIG. 1B shows the distance between the viewer and the screen in FIG. 1A divided into ten parts representing focal point distances.

FIG. 2A illustrates a left/right pixel cross displacement which would cause an object to appear half way between the viewer and the screen at a focal distance of 5.

FIG. 2B illustrates how the same pixel displacement of FIG. 2A but with left and right reversed causes the eyes to focus out to infinity.

FIG. 3 illustrates an example of a left/right (non-crossed) pixel displacement that causes the viewer's eyes to focus behind the screen, in this example, at a focal distance of −7.

FIG. 4 illustrates how the relative focal point distances of objects in a 3D image remain constant regardless of the distance between the viewer and the screen.

FIG. 5 illustrates an example wherein a focal point distance of 5 on a 30 inch display becomes a focal point of 9.4 on a 30 foot screen.

FIG. 6 illustrates a direct (non-normalized) comparison of an image shown on a 30 inch screen and the same image shown both corrected and uncorrected on a 10 foot screen, and the translation of focal points between corrected and uncorrected images.

FIG. 7A illustrates normal eye positions of a viewers eyes focused out to infinity viewing a 30 inch display.

FIG. 7B illustrates an example of an uncorrected image causing a viewer's eyes to be forced to an abnormal direction.

FIG. 8A illustrates an example of an original two-dimensional image that is to be converted into a three-dimensional image.

FIG. 8B illustrates an overlay of the original image of FIG. 8A and a right perspective image derived through a 2D-to-3D conversion process.

FIG. 9A illustrates how the shifting of an image object to create a new perspective can result in hidden surface areas being exposed.

FIG. 9B illustrates an example of a pixel repeat method for filling the hidden surface area of FIG. 9A.

FIG. 9C illustrates an example of how a pixel pattern that results in an image reconstruction more consistent with adjacent or surrounding areas can be used to reconstruct the hidden surface area of FIG. 9A.

FIG. 10 is a diagram illustrating a system, workstation and process for providing 3D images according to an example embodiment of the present invention.

FIGS. 11A and 11B show examples of overlaid left and right perspective images of a three-dimensional image illustrating different amounts of depth applied for smaller and larger screen sizes, respectively.

FIGS. 12A and 12B illustrate examples of an image being provided at smaller and larger-sized screens, respectively, with depth scaling being applied such that the viewer sees an image object at the same focal distance with respect to both screens.

FIG. 13 illustrates an example image file scaling process according to an embodiment of the present invention.

FIG. 14 illustrates an example embodiment of a system for implementing the image processing techniques of the present invention.

### DETAILED DESCRIPTION

The following is a detailed description for carrying out the invention. This description is not to be taken in a limiting sense, but is made merely for the purpose of illustrating the general principles of the invention.

Methods and systems according to the present invention facilitate the creation of 3D images for various screen sizes while ensuring that the 3D images retain a high quality and realistic appearance with respect to the perceived depth placement of components (e.g., objects) within the images. Such methods and systems address the problem of eye fatigue caused by viewing 3D images where the depth placement values associated with the image are not suitable for the screen (image) size.

Various methods and systems of the present invention involve correcting depth placement information associated with image objects for a particular screen (image) size to provide a 3D image for a different sized screen (image) while retaining the perceived depth placement for the image objects.

Various methods and systems of the present invention involve increasing processing performance in the 3D conversion process by scaling down images, processing the resulting lower resolution images to determine 3D conversion information (including but not limited to object depth placement information), and then applying the 3D conversion information to the higher resolution images.

The principles of the present invention are applicable to 3D motion-picture images as well as to 3D still images.

Providing 3D Images for Different Screen (Image) Sizes

A discussion of how our visual senses work and how the brain interprets 3D when stereoscopic 3D images are provided on different screen sizes at different distances is now presented.

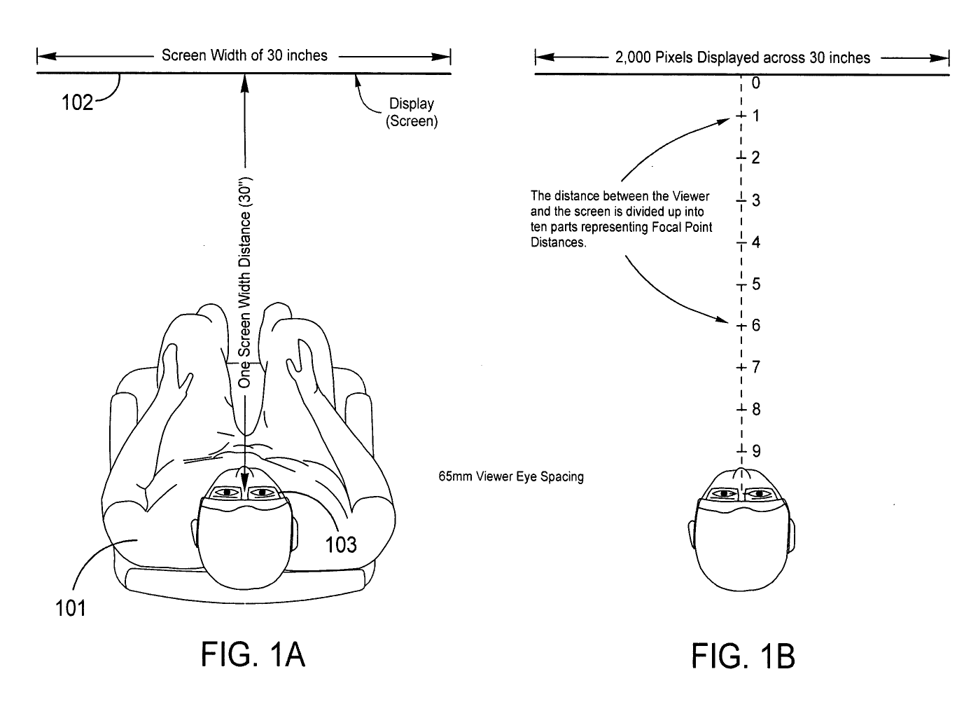

FIG. 1A illustrates a person (viewer) 101 positioned one screen width distance away from a 30 inch wide screen 102. The viewer 101 is wearing a pair of 3D glasses 103 in order to differentiate between the left and right eye images to each eye. In this example, the spacing between the left and right eyes of the viewer 102 is approximately 65 millimeters, the eye spacing distance for the average adult.

FIG. 1B shows the distance between the viewer and the screen in FIG. 1A divided into ten evenly spaced parts representing focal point distances, or points of focal convergence. This example scale can be used to quantify the distances of depth in relation to the screen and the viewer. In this example, focal point distances in front of and behind the screen are indicated as positive and negative numbers, respectively. In each example discussed, the screen has a horizontal resolution of 2,000 pixels across the screen (regardless of the size of the screen).

There is no 3D displacement between the left and right eye images at a focal distance of 0 since both eyes focus to the same point at screen depth, as with a conventional 2D image. In 3D images, perspective essentially causes objects, or pixels that make up the image, to become displaced horizontally in relation to the left and right images. The amount of left/right pixel displacement is what causes eyes to focus either in front of or in back of the screen or display that the image is being presented on.

Objects that are in front of the screen have a crossed pixel displacement. This means that the left image causes the left eye to focus towards the right and the right eye to focus towards the left. If objects are behind the screen, pixels in the left image will be shifted to the left and right image pixels will be shifted to the right.

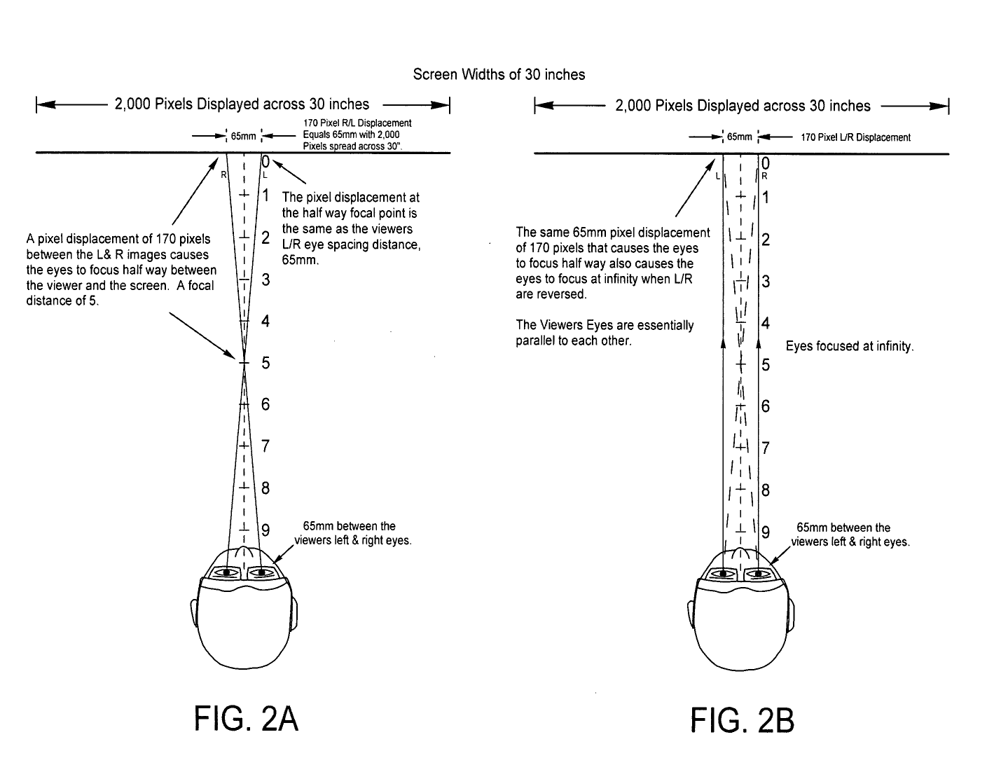

FIG. 2A illustrates how a left/right crossed pixel displacement of 170 pixels causes the eyes to focus half way between the viewer and the screen at a focal point distance of 5. The pixel displacement that causes the eyes to focus half way between the viewer and the screen equals the same distance as the distance between the viewer's left and right eyes. Referring to FIG. 2B, the same pixel displacement but with left and right reversed causes the eyes to focus out to infinity.

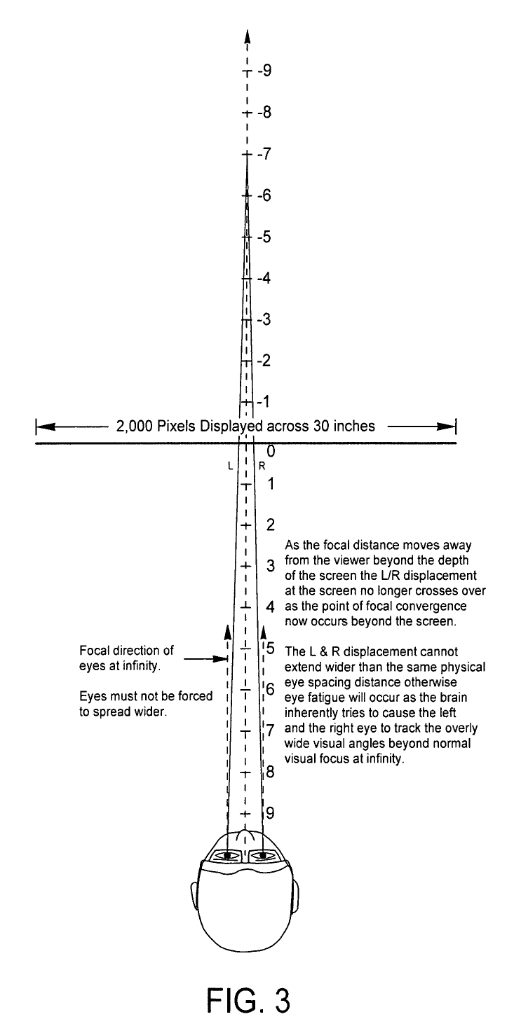

FIG. 3 illustrates an example of a left/right (non-crossed) pixel displacement that causes the viewer's eyes to focus behind the screen, in this example, at a focal distance of −7. As focal distances move away from the viewer beyond the depth distance of the screen, the left/right displacement at the screen no longer crosses over since the point of convergence now occurs beyond the screen. If left and right displacement were to extend wider than the distance between the viewer's eyes, eye fatigue will likely occur as the brain attempts to cause the left and right eyes to track visual angles wider than that of normal visual focus at infinity.

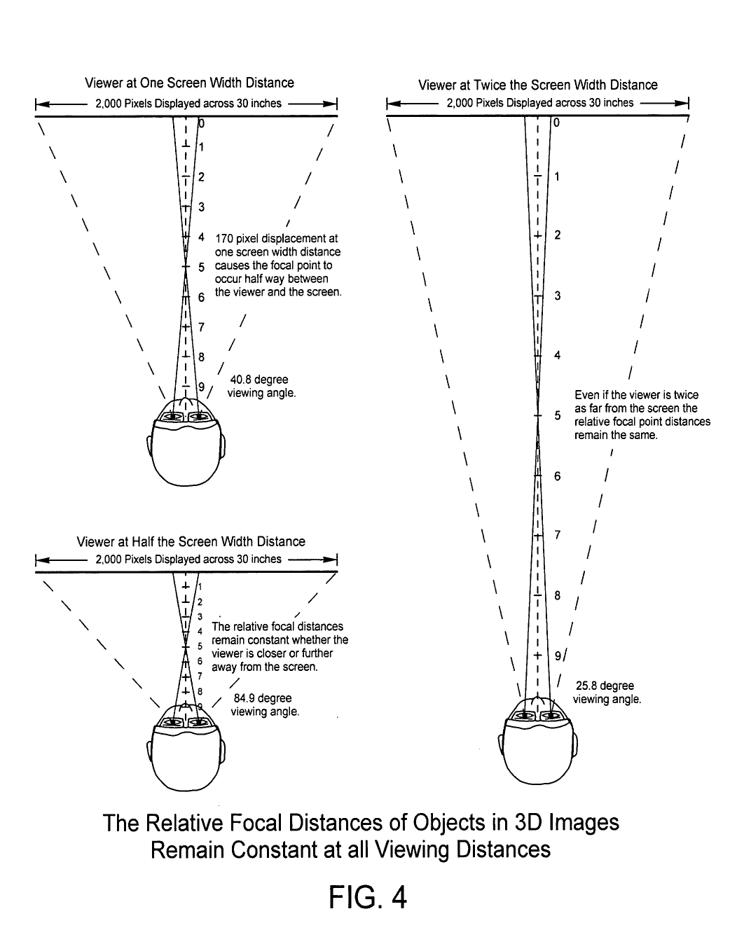

FIG. 4 illustrates how the relative focal point distances of objects in a 3D image remain constant regardless of the distance between the viewer and the screen. When viewing stereoscopic 3D images, objects maintain their relative focal point distances no matter how far the distance between the viewer and the screen. As shown in this example, if an object happens to appear half way between the viewer and the screen at a focal point of 5, that focal point will always be maintained even if the viewer moves closer or further from the screen. Even if the viewer moves twice as far from the screen, the object will still appear half way between the viewer and screen. (This effect is contrary to 3D vision in the real world.) As the viewer moves away from the screen, the image and objects within the image get smaller, but the relative focal point distances remain the same. The ratio of the distance of an object to the screen and the distance of the object to the viewer remains constant. This means that if the viewer moves twice as far away from the object as it appears in relation to the viewer, the apparent change in distance is less than two. In the real world, as a viewer moves away from an object, the object appears smaller and further away. If a viewer doubles his distance from an object, the object appears twice as far away.

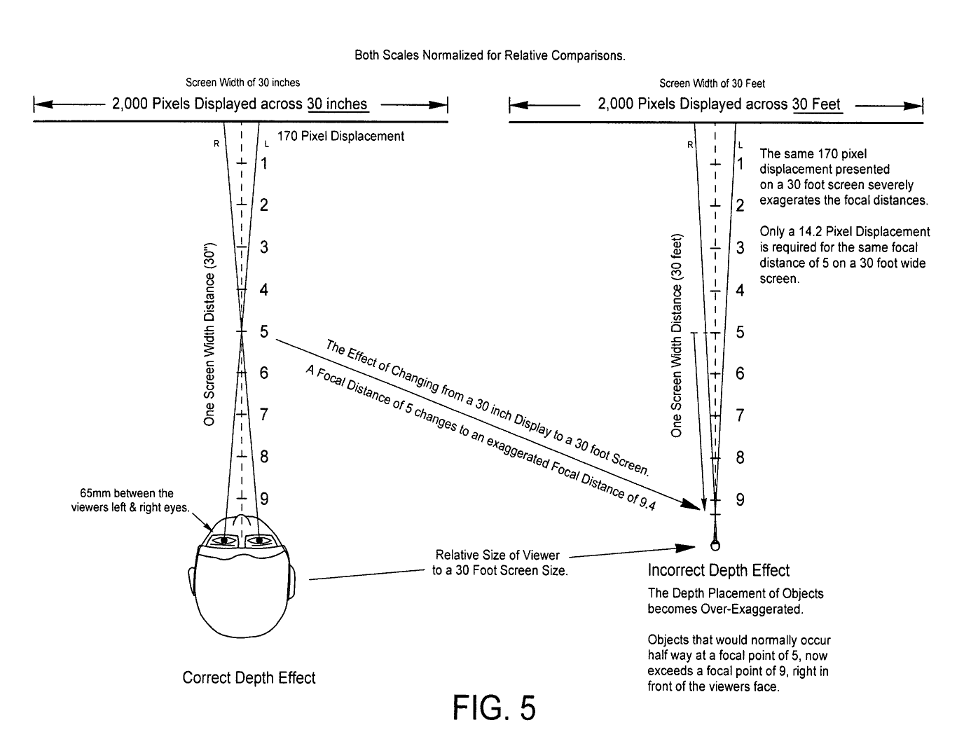

FIG. 5 illustrates an example wherein a focal point distance of 5 on a 30 inch display becomes a focal point of 9.4 on a 30 foot screen. As screen size increases, the 3D left/right image displacements also increase relative to the viewer's, typically 65 mm, eye spacing. This difference in screen size to viewer's eye spacing causes objects in front of the screen to appear to shift more toward the viewer while objects behind the screen appear to shift further away. Essentially, as the screen (image) size increases, the depth effect becomes over-exaggerated. In FIG. 5, the different sized screens in this example are shown normalized to the same size to help illustrate this effect. The same 170 pixel displacement on a 30 inch screen that causes objects to appear half way between the viewer and the screen (at a focal distance of 5), when shown on a 30 foot wide screen, causes the objects to appear much closer to the viewer (at a focal distance greater than 9). In this example, only a 14.2 left/right 3D pixel displacement is needed to produce the same focal point distance of 5 on a 30 foot wide screen.

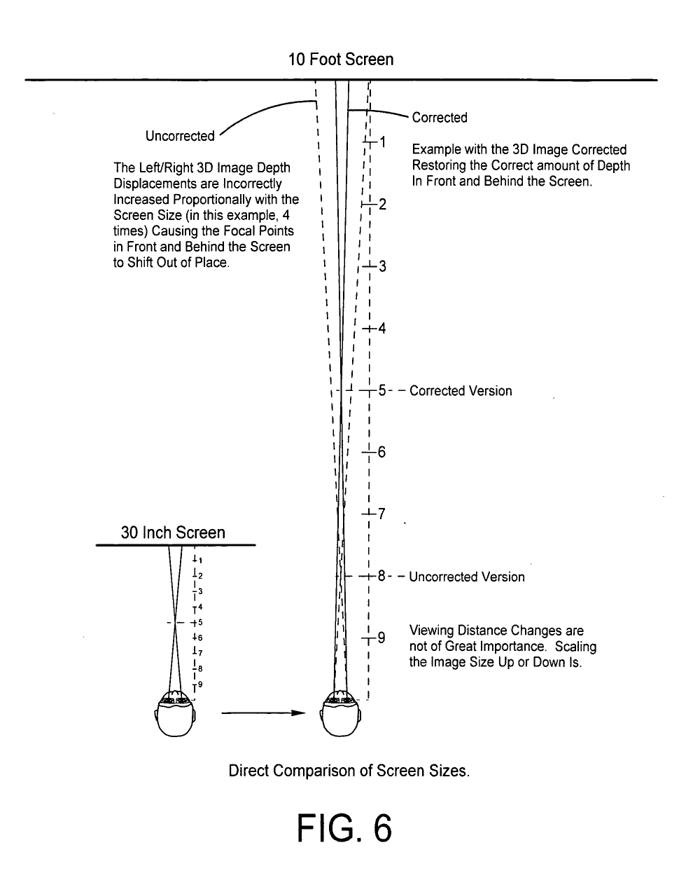

FIG. 6 illustrates a direct (non-normalized) comparison of an image shown on a 30 inch screen and the same image shown both corrected and uncorrected on a 10 foot screen, and the translation of focal points between corrected and uncorrected images. In this example, the viewer (on the left side of the figure) at one screen width distance away from the screen observes an object on the 30 inch wide screen at a focal distance of 5. The same viewer (on right side of the figure) at one screen width away from the 10 foot wide screen observes the same object—for an uncorrected image—at a focal distance of 8, instead of 5, where it should be. In this example, a 3D image created to be shown on the 30 inch wide screen (unless corrected, as discussed below) will appear incorrect with over-exaggerated depth when shown on the 10 foot wide screen.

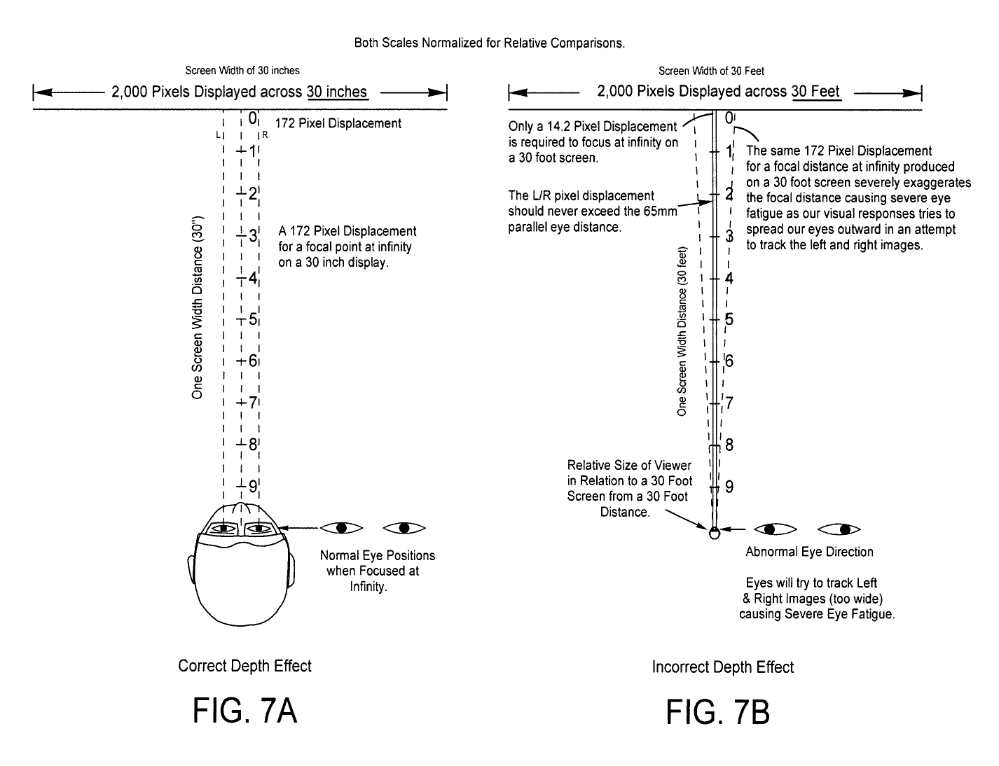

An even worse effect and cause of eye fatigue is the over-exaggeration in depth of background objects (i.e, objects that appear at negative focal distances). Here is why: Referring to FIG. 7A, when the viewer's eyes are focused out toward infinity, each eye is focused to its corresponding left and right eye image virtually straight ahead. As shown, the distance between the objects on the screen out near infinity approaches the same physical distance as the viewer's eye spacing. These may be referred to as the normal eye positions focused at infinity. In this example, with 2,000 pixels displayed across a 30 inch screen, the amount of left/right 3D pixel displacement to cause the equivalent focusing out to infinity is around 170 pixels.

For purposes of conceptual illustration, if the screen is thought of as a 30 inch window of glass placed 30 inches from the viewer's eyes, when the viewer looks through the glass and focuses his eyes out towards infinity, objects at the surface of the glass will appear doubled approximately 65 mm apart. The same holds true if the glass is actually a screen or display. A 3D image can be made to appear at a great distance away from the viewer by having a left/right image displacement approximately 65 mm apart from one another. However, when a 3D image that was created to be shown on a smaller screen is shown on a larger screen the left and right images can, if uncorrected, diverge far enough apart to create no real focal point. This can cause the viewer's eyes to become stressed and fatigued.

FIG. 7B illustrates an example of an uncorrected image causing a viewer's eyes to be forced to an abnormal direction. In this example, the image in FIG. 7A is projected onto a 30 foot screen. In relation to the viewer's eye spacing, only a 14.2 pixel displacement is needed to cause the viewer's eyes to focus out to infinity. If there is no correction made to the image, the 170 pixel left/right displacement that may have appeared correct on the 30 inch display will cause the viewer's eyes to try, in an attempt to focus, to diverge outward wider than the normal eye positions focused at infinity.

The reverse scenario can also be true. If the depth properties of a 3D image are optimized for a 30 foot screen, the viewer seeing the same images on a 30 inch wide display may see little to no depth effect as the depth will become compressed down.

It has been observed that for a given 3D image, as the size of the viewing image increases or decreases, the focal point distances of objects in the image also increase or decrease, respectively. According to various embodiments of the present invention, compensation for such changes in focal point distances is provided so that substantially the same focal distance depth properties for a 3D image can be recreated for a variety of different sized screens (images). In various embodiments, this is accomplished by scaling surface depths applied to image objects and other components to amounts which correlate to a particular output screen (image) size.

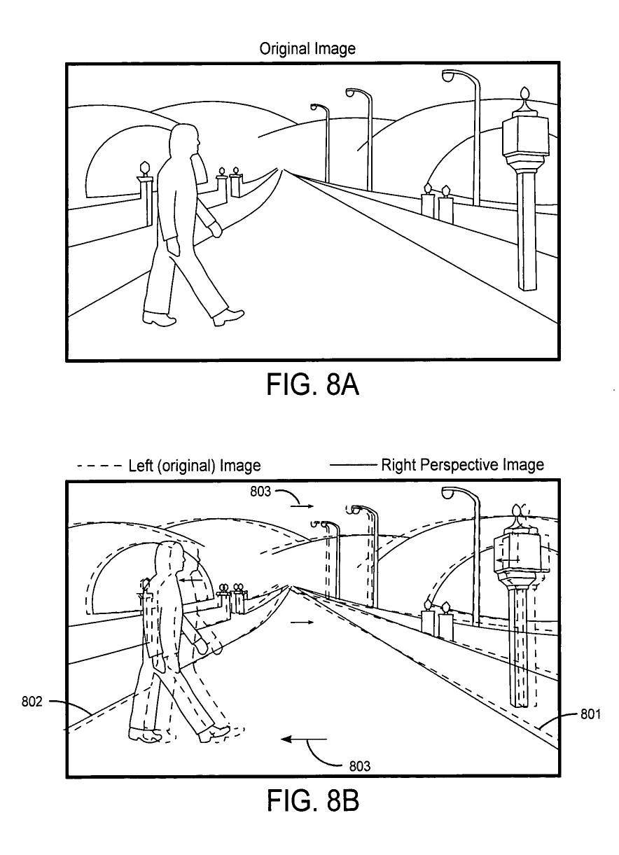

FIG. 8A illustrates an example of an original two-dimensional image that is to be converted into a three-dimensional image. FIG. 8B illustrates an overlay of the original image of FIG. 8A and a right perspective image derived from the original image through a 2D-to-3D conversion process such as the DIMENSIONALIZATION® process developed by In-Three, Inc. of Agoura Hills, Calif. In FIG. 8B, the original image (shown in dashed lines 801) serves as the left perspective view, and the right perspective view image (shown in solid lines 802) is created by horizontally repositioning objects, surfaces and/or other image components of the original image. Arrows 803 indicate the direction that the pixels were shifted relative to the original image to recreate the right perspective view image.

In the process of creating a new perspective of an image, the positions of objects may be shifted resulting in gaps between foreground and background. These gaps, or areas, between old and new object positions are referred to as “hidden surface areas”. Hidden surface areas are essentially areas that become revealed by virtue of the different perspective angle of view. Sometimes these areas may also be referred to as “occluded areas”, but they are the same as hidden surface areas.

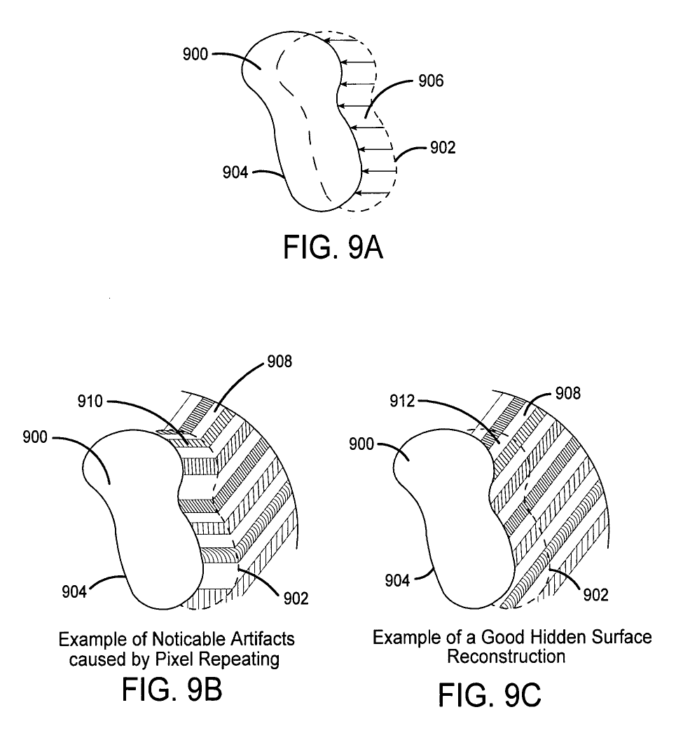

FIG. 9A illustrates an example image object 900 shifted from an original object position denoted by an object boundary 902 shown in dashed lines to a new object position denoted by an object boundary 904 to create a new (right) perspective. In this example, a hidden surface area 906 between the object boundaries 902 and 904 results from shifting the image object 900 horizontally to the left.

Hidden surface areas may be noticeable in a resulting 3D image, unless they are appropriately filled or otherwise reconstructed. Referring to FIG. 9B, one method for filling the hidden surface areas is to pixel repeat across the gap area. In this example, image information from the edge of an object 908 is horizontally repeated across the gap area. The problem with this approach, as shown, is that the repeated image information is often too inconsistent with surrounding areas, which may result in noticeable image artifacts. In this example, a pixel pattern 910 repeated across the area gap is inconsistent with the pattern of surrounding object 908 resulting in a distracting and noticeable artifact.

FIG. 9C illustrates an example of how a pixel pattern 912 that results in an image reconstruction more consistent with adjacent or surrounding areas can be used to reconstruct the area gap between the object boundaries 902 and 904. Another method for reconstructing hidden surface areas is described in U.S. patent application Ser. No. 10/316,672 entitled “Method Of Hidden Surface Reconstruction For Creating Accurate Three-Dimensional Images Converted From Two-Dimensional Images”. Generally, the approach of the prior application involves utilizing image pixel information that either becomes revealed in other frames or is reconstructed from information within the same frames. In either case, if an original image is established as one of the perspectives for the 3D image only a single additional perspective image needs to be created. Moreover, when an original image is established as one of the perspective views of the 3D image being created, this original image can remain unaltered and the process of hidden surface area reconstruction only needs if at all to be applied to the complementary perspective image. If both perspective images had to have their hidden surface areas processed, twice as much work would be required.

According to various embodiments of the present invention, a method for providing a three-dimensional image includes reconstructing hidden surface areas as well as scaling depth information associated with objects in the three-dimensional image to preserve perceived depths of the objects when the three-dimensional image is presented at a particular screen size, multiple screen sizes, or within a particular range of screen sizes. According to an embodiment of the present invention, a method for providing a three-dimensional image includes scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes. The scaling can be performed on an image used to create the three-dimensional image or on a lower resolution version of an image used to create the three-dimensional image. In various embodiments, the scaling is performed at an interactive user interface configured to allow a user of the interactive user interface to view the three-dimensional image and/or a lower resolution version of the three-dimensional image during the scaling.

According to an embodiment of the present invention, a method for providing a three-dimensional image includes selecting a screen size or range of screen sizes for a three-dimensional image, and scaling depth information associated with objects in a three-dimensional image to preserve perceived depths of the objects when the three-dimensional image is presented at the screen size or within the range of screen sizes selected. The depth information can be scaled down or up. In various embodiments, the depth information is scaled using an interactive user interface configured to allow a user of the interactive user interface to view a representation of the three-dimensional image during the scaling of the depth information. In various embodiments, the depth information is at least partially automatically scaled depending upon the screen size or the range of screen sizes selected. Another embodiment of the method for providing a three-dimensional image further includes scaling hidden surface reconstruction information associated with hidden surface areas in the three-dimensional image to preserve reconstructions of the hidden surface areas when the three-dimensional image is presented at the screen size or within the range of screen sizes selected. The hidden surface reconstruction information can be scaled down or up. In various embodiments, the hidden surface reconstruction information is scaled using an interactive user interface configured to allow a user of the interactive user interface to view a representation of the three-dimensional image during the scaling of the hidden surface reconstruction information. In various embodiments, the hidden surface reconstruction information is at least partially automatically scaled depending upon the screen size or the range of screen sizes selected.

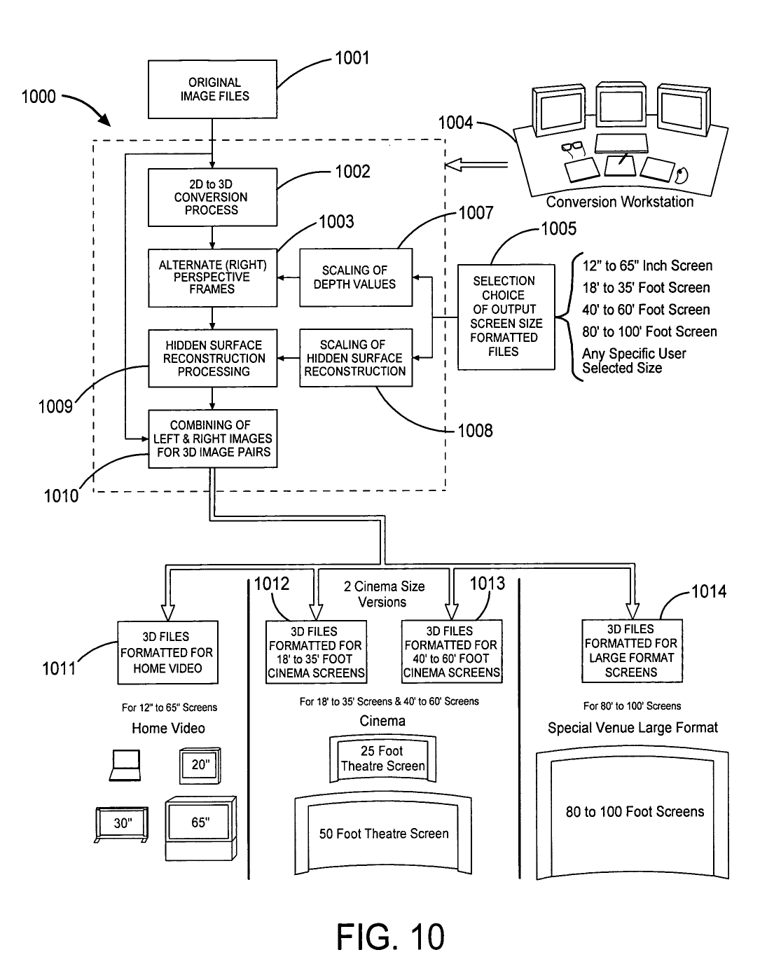

FIG. 10 is a diagram illustrating a system, workstation and process for providing 3D images 1000 according to an example embodiment of the present invention. In this example embodiment, original image files 1001 are provided as inputs into a 2D-to-3D conversion process 1002, such as the DIMENSIONALIZATION® process, which generates alternative (e.g., right) perspective frames 1003. The original image files 1001 can be any form of image data or information and are not limited to any particular type of data file or format. In this example embodiment, a conversion workstation 1004 is configured with a variety of software tools and user interfaces that allow a user to produce an alternate perspective angle view for each frame. To this end, the conversion workstation 1004 in this example embodiment is configured to allow the user to apply pixel shifting algorithms and the like to reconstruct depth in the images. For example, the conversion workstation 1004 includes software tools that allow the user to construct variable and continuous depth data for object surfaces.

In this example embodiment, the conversion workstation 1004 is also configured to allow the user to specify an output screen size or range of output screen sizes, so that perceived depths of objects or other components within the three-dimensional image will be preserved when the three-dimensional image is presented at the specified screen size or range of screen sizes. By way of example, a user selected choice of output screen size formatted files 1005 is provided as an input to the process for providing 3D images 1000. Example ranges of output screen sizes include, but are not limited to: 12-65 inch screen sizes, 18-35 foot screen sizes, 40-60 foot screen sizes, and 80-100 foot screen sizes. In various embodiments, the user can specify any screen size, multiple screen sizes, or a range of screen sizes. As shown in this example, the user selected choice of output screen size formatted files 1005 is provided as an input to processing steps 1007 and 1008 for scaling of depth values of hidden surface reconstructions, respectively. Once the 2D-to-3D conversion process 1002 is complete, a user specified output screen size (such as an 80-100 foot large venue screen size) is used at step 1007 to scale the depth values employed at the process step 1003 to create the alternate perspective frames so that the focal point distances will match that large screen size. The specified output screen size is also used at step 1008 to provide scaling for a step 1009 during which hidden surface reconstruction processing (discussed above) is performed. In one embodiment, hidden surface reconstruction information is scaled depending upon the specified output screen size. The amount of scaling appropriate for a particular image object or other component can be empirically or otherwise determined (e.g., calculated based on selected output screen sizes and/or depth values previously associated with the image object or other component). At step 1010, the left and right images are combined to provide a 3D image pair. Output data files for the 3D images are generated depending upon the specified output screen size. In this example, the conversion workstation 1004 is configured to allow the user to control the generation of multiple various screen size output files. In this example, 3D data files 1011 suitable for home video are generated when the 12-65 inch output screen size is specified, 3D data files 1012 suitable for 18-35 foot cinema screens are generated when the 18-35 foot output screen size is specified, 3D data files 1013 suitable for 40-60 foot cinema screens are generated when the 40-60 foot output screen size is specified, and 3D data files 1014 suitable for 80-100 foot large format screens are generated when the 80-100 foot output screen size is specified. It should be appreciated that the ranges of screen sizes discussed above are merely examples and that the principals of the present invention are equally applicable to methods for providing 3D image for other screen (or image) sizes that those specifically disclosed herein.

According to an embodiment of the present invention, a method for providing a three-dimensional image includes providing a machine-readable data file that includes scaling depth information associated with objects in a three-dimensional image, the scaling depth information being usable to preserve perceived depths of the objects within the three-dimensional image when the three-dimensional image is presented at a particular screen size or within a particular range of screen sizes. According to another embodiment of the present invention, a method for providing a three-dimensional image includes providing a machine-readable data file that includes scaling hidden surface reconstruction information associated with hidden surface areas in a three-dimensional image, the scaling hidden surface reconstruction information being usable to preserve reconstructions of the hidden surface areas when the three-dimensional image is presented at a particular screen size or within a particular range of screen sizes.

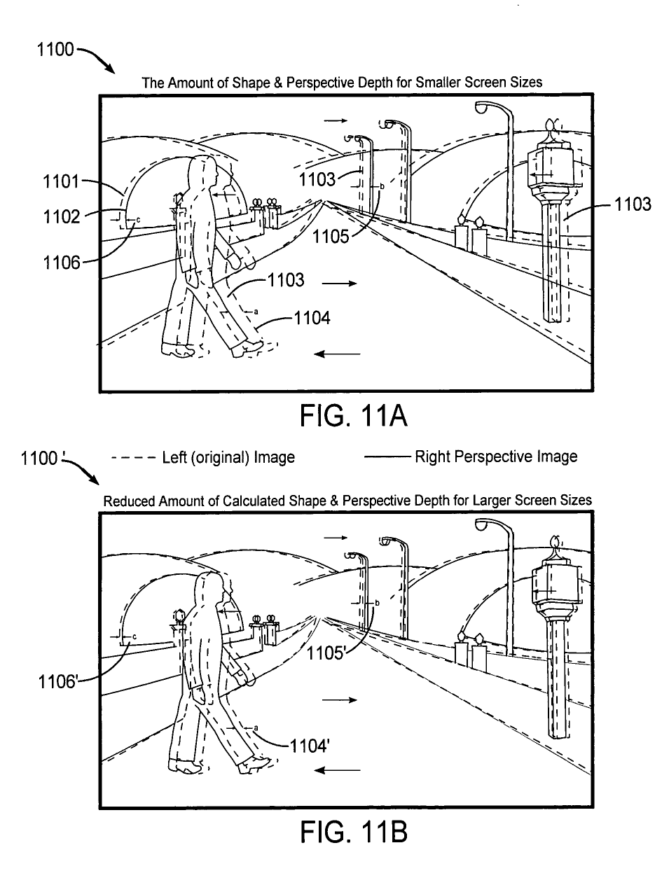

FIGS. 11A and 11B illustrate how different amounts of depth can be applied depending upon the screen size specified. In FIG. 11A, an example of overlaid left and right perspective images of a three-dimensional image 1100 illustrates an amount of depth applied for smaller screen sizes (e.g., a 21-inch monitor display). In FIG. 11B, an example of overlaid left and right perspective images of a three-dimensional image 1100′ illustrates a reduced amount of depth applied for larger screen sizes. Referring again to FIG. 11A, objects in the left perspective image (e.g., the original image) are shown with dashed lines 1101 and objects in the right perspective image (e.g., the alternate perspective created from the original image) are shown with solid lines 1102. In this example, hidden surface areas 1103 were also reconstructed to eliminate or lessen the likelihood of noticeable image artifacts being present in the three-dimensional image 1100. In this example, depth values were applied to image objects 1104, 1105 and 1106 of the left perspective image to horizontally shift these image objects for creating the right perspective image. According to various embodiments of the present invention, the amount of depth applied to objects is scaled depending upon the screen (or image) size specified for the 3D image being created. In FIG. 11B, the amount of depth applied is reduced to accommodate a larger screen size. As shown in this example, the amount of pixel displacement for the image objects 1104′, 1105′ and 1106′ is less than in FIG. 11A.

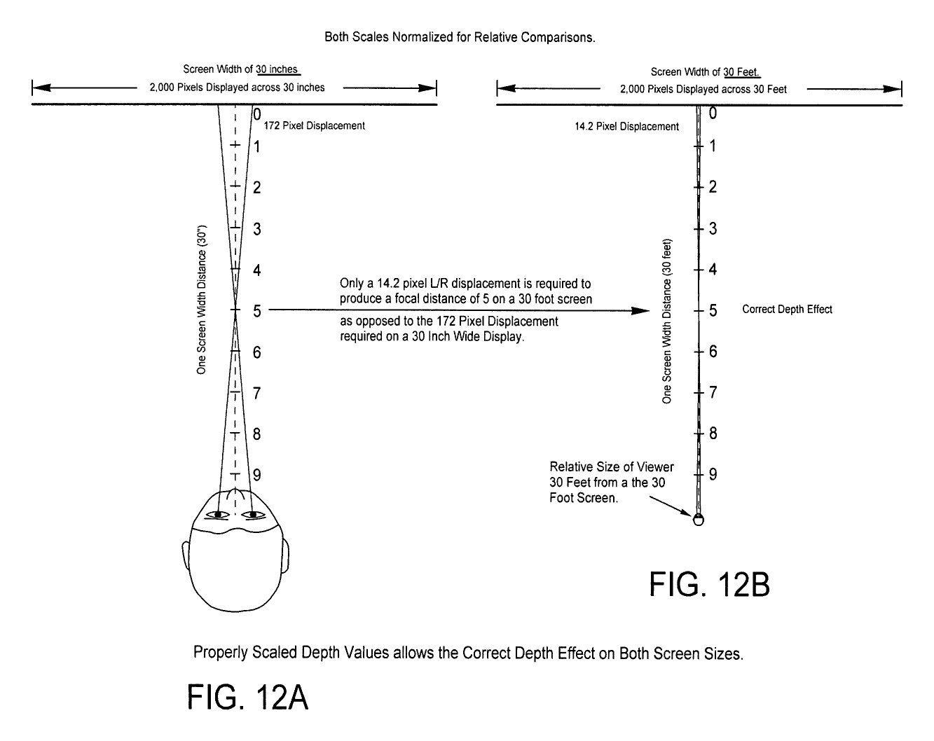

FIGS. 12A and 12B illustrate examples of an image being provided at smaller and larger-sized screens, respectively, with depth scaling being applied such that the viewer sees an image object at the same focal distance with respect to both screens. As shown in these examples, the viewer perceives a particular effect on both screens at a focal point distance of 5. This is because, in these examples, the focal point distance depth scales have been matched. As shown in FIG. 12A, on the 30 inch wide display, a 172 pixel displacement causes a focal point distance of 5. As shown in FIG. 12B, on the 30 foot wide display, a 14.2 pixel displacement causes a focal point distance of 5. Of course, it should be understood that image objects and other components can have focal point distances other than 5, and that any such focal point distance is amenable to depth scaling according to various embodiments of the present invention. By scaling depth and/or hidden surface reconstruction information for files generated for particular screen sizes, desired depth effects can be preserved regardless of whether a 3D image previously created for a smaller screen (image) size is scaled for a larger screen (image) size or vice versa. The positions of the cameras and lens focal lengths used to photograph the images may also have an effect on the apparent scaling of depth for a 3D image.

Increasing Processing Performance in the 3D Conversion Process

In various embodiments of the present invention, the system is configured to provide the ability to scale down higher resolution images to permit at least part of the 2D-to-3D conversion process to be performed on lower resolution images. This potentially increases the overall speed at which 3D images are generated because more computing resources are typically required to process the larger file sizes of higher resolution images (e.g., 4096×2160 pixels) than the smaller file sizes of lower resolution images (e.g., 2048×1080 pixels). It has been observed that there is no appreciable degradation in resulting 3D image quality when portions of the 2D-to-3D conversion process are performed on lower resolution images. As discussed below, various embodiments of the present invention exploit this observation to the end of optimizing or shortening the processing time for generating 3D images from high resolution images.

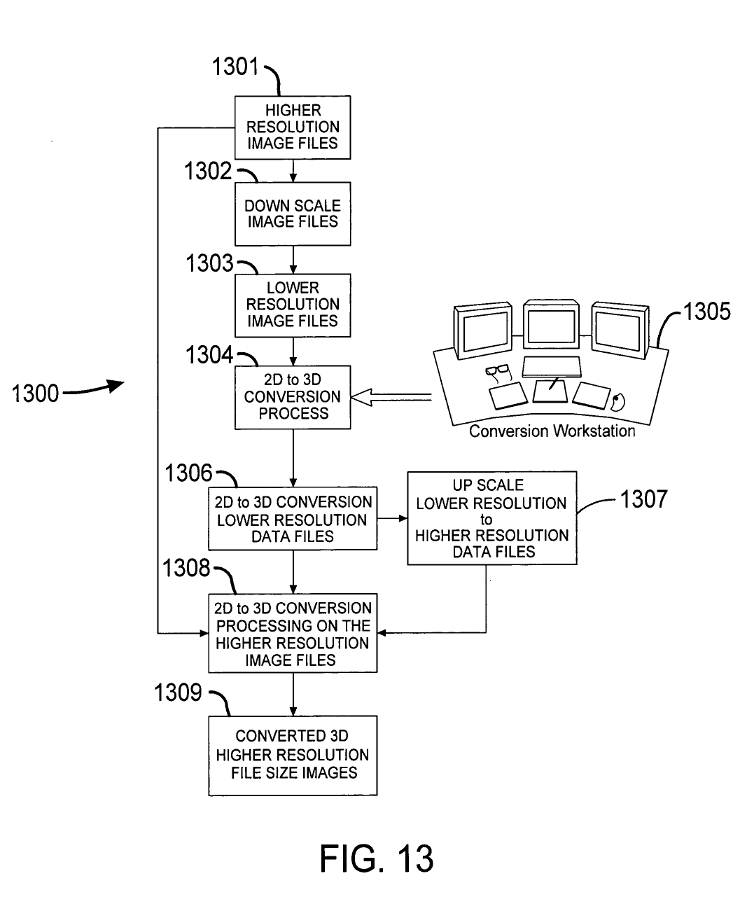

FIG. 13 illustrates an example image file scaling process 1300 according to an embodiment of the present invention. In this example flow diagram, higher resolution image files 1301 (e.g., 4K image files) are downscaled at step 1302 to lower resolution image files 1303 (e.g., 2K image files). Alternatively, or in addition to scaling down the higher resolution image files, the downscaling step 1302 can include reducing the color depth size, for example, down to 2 bytes per pixel. It should be appreciated that the downscaling step 1302 can also include other types of image file downscaling. After the downscaling step 1302, a 2D-to-3D conversion process 1304, such as the DIMENSIONALIZATION® process, is performed on the lower resolution image files 1303. In this example, a conversion workstation 1305 is used (e.g., by a DIMENSIONALIST™) to control and/or provide inputs for the 2D-to-3D conversion process 1304 (e.g., selecting and using software tools within the system to provide depth perspective and recover hidden surfaces) while viewing images generated from the lower resolution image files 1303. For example, the 2D-to-3D conversion process 1304 is performed on images that have been scaled down to a smaller number of pixels and/or a smaller color depth size. In some instances, it has been observed that it is not of critical importance in relation to the quality of the 3D images ultimately generated to perform the 2D-to-3D conversion process 1304 on images that have high resolution and color depth. Various embodiments of the present invention exploit this observation by providing a mechanism for performing the 2D-to-3D conversion process 1304 on smaller sized image files. This increases the system processing speed and, thus, potentially lessens the incidence of processing delays that will slow the speed at which an operator can make and input aesthetic and other decisions that are pertinent to the 2D-to-3D conversion process 1304.

As the operator performs the 2D-to-3D conversion process, lower resolution object files 1306 that contain depth and other information and decisions associated with the 2D-to-3D conversion process are created at a scale proportional to or otherwise suitable for the lower resolution images. The lower resolution object files 1306, in turn, are scaled up to the higher resolution to create higher resolution object files 1307 so that the depth and other information and decisions associated with the 2D-to-3D conversion process can be fitted to the higher resolution images. At an appropriate time, the higher resolution object files 1307 provide appropriately scaled depth and other information and decisions associated with the 2D-to-3D conversion process that can be used at step 1308 to perform 2D-to-3D processing on the higher resolution image files to generate higher resolution 3D image files 1309 with high color depth fidelity. Once the operator decisions/inputs have been made with respect to the lower resolution images, the system can process the higher resolution image files at high color bit depth either on the same workstation or on a separate (independent) workstation which potentially increases efficiency by freeing the conversion workstation 1305 for continued use processing images at the lower resolution.

Thus, according to an embodiment of the present invention, a method for providing a three-dimensional image includes scaling down higher resolution images to generate lower resolution images, processing the lower resolution images to determine three-dimensional conversion information and applying the three-dimensional conversion information to the higher resolution images to create three-dimensional images.

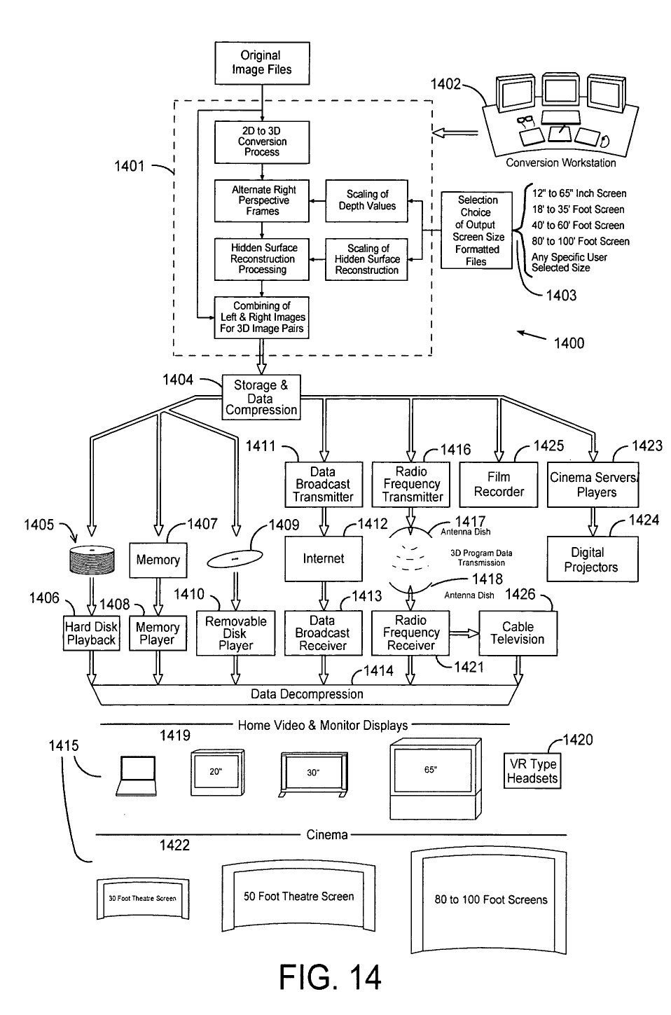

Various principles of the present invention are embodied in an interactive user interface and a plurality of image processing tools that allow a user to rapidly convert a large number of images or frames to create authentic and realistic appearing three-dimensional images. FIG. 14 illustrates an example embodiment of a system 1400 for implementing the image processing techniques of the present invention. In this example, 2D-to-3D conversion processing 1401 is implemented and controlled by a user working at a conversion workstation 1402. It is here, at the conversion workstation 1402, that the user gains access to the interactive user interface and the image processing tools and controls and monitors the results of the 2D-to-3D conversion processing 1401. For example, the user can select a set of output files 1403 that correspond to a particular size or range of screen sizes that the 3D content is to be presented on. According to various embodiments of the present invention, this 3D content is created such that depth effects appear “correct”, i.e., not over or under exaggerated, on a particular screen size or range of screen sizes. According to various embodiments of the present invention, 2D-to-3D conversion processing of large image files is separated from, or distributed with respect to, the process of making and inputting depth and other information and decisions associated with the 2D-to-3D conversion process. By way of example, and as discussed above, this can be accomplished by using smaller sized image files to make and input the depth and other information and decisions and then, when finalized, applying these depth and other information and decisions to larger sized image files. It should be understood that any of the processing functions described herein can be performed by one or more processor/controller. Moreover, these functions can be implemented employing a combination of software, hardware and/or firmware taking into consideration the particular requirements, desired performance levels, etc. for a given system or application.

The three-dimensional converted product and its associated working files can be stored (storage and data compression 1404) on hard disk, in memory, on tape, or on any other data storage device. In the interest of conserving space on the above-mentioned storage devices, the information can be compressed; otherwise files sizes may become extraordinarily large especially when full-length motion pictures are involved. Data compression can also be used to accommodate the bandwidth limitations of broadcast transmission channels and the like.

The three-dimensional converted content data can be stored in many forms. The data can be stored on a hard disk 1405 (for hard disk playback 1406), in removable or non-removable memory 1407 (for use by a memory player 1408), or on removable disks 1409 (for use by a removable disk player 1410) which may include but are not limited to digital versatile disks (dvd's). The three-dimensional converted product can also be compressed into the bandwidth necessary to be transmitted by a data broadcast receiver 1411 across the Internet 1412, and then received by a data broadcast receiver 1413 and decompressed (data decompression 1414) making it available for use via various 3D capable display devices 1415. Similar to broadcasting over the Internet, the product created by the present invention can be transmitted by way of electromagnetic or RF (radio frequency) transmission by a radio frequency transmitter 1416. This includes direct conventional television transmission, as well as satellite transmission employing an antenna dish 1417 which is currently more prevalent. The content created by way of the present invention can be transmitted by satellite and received by an antenna dish 1418, decompressed, and viewed on home video type monitor/receiver displays 1419, possibly incorporating cathode ray tubes (CRT's), flat display panels such as a plasma display panel (PDP) or liquid crystal display (LCD), a front or rear projector in the home, industry, or in the cinema, or a virtual reality (VR) type of headset 1420. If the three-dimensional content is broadcast by way of RF transmission, the receiver 1421 can in feed decompression circuitry or feed a display device directly. It should be noted however that the content product produced by the present invention is not limited to compressed data formats. The product can also be used in an uncompressed form. The content product produced by the present invention can be used in the cinema on a multitude of different screen sizes 1422. The various files for any particular screen size or range of screen sizes can be recorded and played off of Cinema server players 1423 and fed into digital cinema projectors 1424. The product can also be recorded to film on a film recorder 1425. Another use for the product and content produced by the present invention is cable television 1426.

Thus, according to an embodiment of the present invention, a method for providing a three-dimensional image includes receiving or accessing image data created by scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes, and using the image data to reproduce a three-dimensional image. By way of example, using the image data to reproduce the three-dimensional image includes displaying and/or projecting the three-dimensional image.

According to an embodiment of the present invention, a method for providing three-dimensional images includes receiving or accessing image data created by scaling depth and/or hidden surface area reconstruction information associated with three-dimensional images in order to preserve perceived depths of objects or other image components within the three-dimensional images when the three-dimensional images are presented at a particular screen size, multiple screen sizes, or within a particular range of screen sizes, and projecting the three-dimensional images on movie screens. By way of example, the three-dimensional images are projected using a film media, or the three-dimensional images are digitally projected.

According to an embodiment of the present invention, a method for providing three-dimensional images includes receiving or accessing image data created by scaling depth and/or hidden surface area reconstruction information associated with three-dimensional images in order to preserve perceived depths of objects or other image components within the three-dimensional images when the three-dimensional images are presented at a particular screen size, multiple screen sizes, or within a particular range of screen sizes, and displaying the three-dimensional images in a home theatre environment.

According to an embodiment of the present invention, a method for providing three-dimensional images includes receiving or accessing image data created by scaling depth and/or hidden surface area reconstruction information associated with three-dimensional images in order to preserve perceived depths of objects or other image components within the three-dimensional images when the three-dimensional images are presented at a particular screen size, multiple screen sizes, or within a particular range of screen sizes, and displaying the three-dimensional images on a video display. By way of example, the video display can be a television, a television-type display, a television-type home video display, or a computer monitor.

According to an embodiment of the present invention, a method for providing a three-dimensional image includes receiving or accessing image data created by scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes, and recording the image data on a data storage device. By way of example, the data storage device can be a movie storage device suitable for use in movie theatres. Also by way of example, the data storage can be a server, a hard drive, a digital media disk, or a digital versatile disk. In various embodiments, the image data is recorded such that the data storage device can be used to reproduce the three-dimensional image with a digital projector. In various embodiments, the image data is recorded such that the data storage device can be used to reproduce the three-dimensional image on a video display, a television, a television-type display, a television-type home video display and/or a computer monitor.

According to an embodiment of the present invention, a method for providing a three-dimensional image includes receiving or accessing image data created by scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes, and using an electromagnetic transmission medium (e.g., radio waves) to transmit the image data.

According to an embodiment of the present invention, a method for providing a three-dimensional image includes receiving or accessing image data created by scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes, and using a communications network to transmit the image data. By way of example, the communications network can include the Internet and/or other networks.

Although the present invention has been described in terms of the example embodiments above, numerous modifications and/or additions to the above-described embodiments would be readily apparent to one skilled in the art. It is intended that the scope of the present invention extends to all such modifications and/or additions.

1. A method for providing a three-dimensional image, comprising:
selecting a screen size or range of screen sizes for a three-dimensional image; and
scaling depth information associated with objects in a three-dimensional image to preserve perceived depths of the objects when the three-dimensional image is presented at the screen size or within the range of screen sizes selected.

2. The method for providing a three-dimensional image of claim 1, wherein the depth information is scaled down.

3. The method for providing a three-dimensional image of claim 1, wherein the depth information is scaled up.

4. The method for providing a three-dimensional image of claim 1, wherein the depth information is scaled using an interactive user interface configured to allow a user of the interactive user interface to view a representation of the three-dimensional image during the scaling of the depth information.

5. The method for providing a three-dimensional image of claim 1, wherein the depth information is at least partially automatically scaled depending upon the screen size or the range of screen sizes selected.

6. The method for providing a three-dimensional image of claim 1, further comprising:
scaling hidden surface reconstruction information associated with hidden surface areas in the three-dimensional image to preserve reconstructions of the hidden surface areas when the three-dimensional image is presented at the screen size or within the range of screen sizes selected.

7. The method for providing a three-dimensional image of claim 6, wherein the hidden surface reconstruction information is scaled down.

8. The method for providing a three-dimensional image of claim 6, wherein the hidden surface reconstruction information is scaled up.

9. The method for providing a three-dimensional image of claim 6, wherein the hidden surface reconstruction information is scaled using an interactive user interface configured to allow a user of the interactive user interface to view a representation of the three-dimensional image during the scaling of the hidden surface reconstruction information.

10. The method for providing a three-dimensional image of claim 6, wherein the hidden surface reconstruction information is at least partially automatically scaled depending upon the screen size or the range of screen sizes selected.

11. A method for providing a three-dimensional image, comprising:
providing a machine-readable data file that includes scaling depth information associated with objects in a three-dimensional image, the scaling depth information being usable to preserve perceived depths of the objects within the three-dimensional image when the three-dimensional image is presented at a particular screen size or within a particular range of screen sizes.

12. A method for providing a three-dimensional image, comprising:
providing a machine-readable data file that includes scaling hidden surface reconstruction information associated with hidden surface areas in a three-dimensional image, the scaling hidden surface reconstruction information being usable to preserve reconstructions of the hidden surface areas when the three-dimensional image is presented at a particular screen size or within a particular range of screen sizes.

13. A method for providing a three-dimensional image, comprising:
scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes.

14. The method for providing a three-dimensional image of claim 13, wherein the scaling is performed on an image used to create the three-dimensional image.

15. The method for providing a three-dimensional image of claim 13, wherein the scaling is performed at an interactive user interface configured to allow a user of the interactive user interface to view the three-dimensional image during the scaling.

16. The method for providing a three-dimensional image of claim 13, wherein the scaling is performed on a lower resolution version of an image used to create the three-dimensional image.

17. The method for providing a three-dimensional image of claim 13, wherein the scaling is performed at an interactive user interface configured to allow a user of the interactive user interface to view a lower resolution version of the three-dimensional image during the scaling.

18. A method for providing a three-dimensional image, comprising:
scaling down higher resolution images to generate lower resolution images;
processing the lower resolution images to determine three-dimensional conversion information; and
applying the three-dimensional conversion information to the higher resolution images to create three-dimensional images.

19. The method for providing a three-dimensional image of claim 18, wherein scaling down includes reducing an image file size of the higher resolution images to generate the lower resolution images.

20. The method for providing a three-dimensional image of claim 18, wherein scaling down includes reducing a number of pixels of the higher resolution images to generate the lower resolution images.

21. The method for providing a three-dimensional image of claim 18, wherein scaling down includes reducing a color depth size of the higher resolution images to generate the lower resolution images.

22. The method for providing a three-dimensional image of claim 18, wherein the three-dimensional conversion information includes depth perspective information.

23. The method for providing a three-dimensional image of claim 18, wherein the three-dimensional conversion information includes hidden surface reconstruction information.

24. The method for providing a three-dimensional image of claim 18, wherein the three-dimensional conversion information is scaled up before it is applied to the higher resolution images.

25. A method for providing a three-dimensional image, comprising:
receiving or accessing image data created by scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes; and
using the image data to reproduce a three-dimensional image.

26. The method for providing a three-dimensional image of claim 25, wherein using the image data to reproduce the three-dimensional image includes displaying the three-dimensional image.

27. The method for providing a three-dimensional image of claim 25, wherein using the image data to reproduce the three-dimensional image includes projecting the three-dimensional image.

28. A method for providing three-dimensional images, comprising:
receiving or accessing image data created by scaling depth and/or hidden surface area reconstruction information associated with three-dimensional images in order to preserve perceived depths of objects or other image components within the three-dimensional images when the three-dimensional images are presented at a particular screen size, multiple screen sizes, or within a particular range of screen sizes; and
projecting the three-dimensional images on movie screens.

29. The method for providing three-dimensional images of claim 28, wherein the three-dimensional images are projected using a film media.

30. The method for providing three-dimensional images of claim 28, wherein the three-dimensional images are digitally projected.

31. A method for providing three-dimensional images, comprising:
receiving or accessing image data created by scaling depth and/or hidden surface area reconstruction information associated with three-dimensional images in order to preserve perceived depths of objects or other image components within the three-dimensional images when the three-dimensional images are presented at a particular screen size, multiple screen sizes, or within a particular range of screen sizes; and
displaying the three-dimensional images in a home theatre environment.

32. A method for providing three-dimensional images, comprising:
receiving or accessing image data created by scaling depth and/or hidden surface area reconstruction information associated with three-dimensional images in order to preserve perceived depths of objects or other image components within the three-dimensional images when the three-dimensional images are presented at a particular screen size, multiple screen sizes, or within a particular range of screen sizes; and
displaying the three-dimensional images on a video display.

33. The method for providing three-dimensional images of claim 32, wherein the video display is a television.

34. The method for providing three-dimensional images of claim 32, wherein the video display is a television-type display.

35. The method for providing three-dimensional images of claim 32, wherein the video display is a television-type home video display.

36. The method for providing three-dimensional images of claim 32, wherein the video display is a computer monitor.

37. A method for providing a three-dimensional image, comprising:
receiving or accessing image data created by scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes; and
recording the image data on a data storage device.

38. The method for providing a three-dimensional image of claim 37, wherein the data storage device is a movie storage device suitable for use in movie theatres.

39. The method for providing a three-dimensional image of claim 37, wherein the data storage device is a server.

40. The method for providing a three-dimensional image of claim 37, wherein the data storage device is a hard drive.

41. The method for providing a three-dimensional image of claim 37, wherein the data storage device is a digital media disk.

42. The method for providing a three-dimensional image of claim 37, wherein the data storage device is a digital versatile disk.

43. The method for providing a three-dimensional image of claim 37, wherein the image data is recorded such that the data storage device can be used to reproduce the three-dimensional image with a digital projector.

44. The method for providing a three-dimensional image of claim 37, wherein the image data is recorded such that the data storage device can be used to reproduce the three-dimensional image on a video display.

45. The method for providing a three-dimensional image of claim 37, wherein the image data is recorded such that the data storage device can be used to reproduce the three-dimensional image on a television.

46. The method for providing a three-dimensional image of claim 37, wherein the image data is recorded such that the data storage device can be used to reproduce the three-dimensional image on a television-type display.

47. The method for providing a three-dimensional image of claim 37, wherein the image data is recorded such that the data storage device can be used to reproduce the three-dimensional image on a television-type home video display.

48. The method for providing a three-dimensional image of claim 37, wherein the image data is recorded such that the data storage device can be used to reproduce the three-dimensional image on a computer monitor.

49. A method for providing a three-dimensional image, comprising:
receiving or accessing image data created by scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes; and
using an electromagnetic transmission medium to transmit the image data.

50. The method for providing a three-dimensional image of claim 49, wherein the electromagnetic transmission medium includes radio waves.

51. A method for providing a three-dimensional image, comprising:
receiving or accessing image data created by scaling depth and/or hidden surface area reconstruction information associated with a three-dimensional image to preserve perceived depths of objects or other image components within the three-dimensional image when the three-dimensional image is presented at a particular screen size, multiple screen sizes, or within a particular range of screen sizes; and
using a communications network to transmit the image data.

52. The method for providing a three-dimensional image of claim 51, wherein the communications network includes the Internet.
